(19) United States
(12) Patent Application Publication
(10) Pub. No.: US 2006/0095620 A1
(43) Pub. Date: May 4, 2006

(54) System, method and storage medium for merging bus data in a memory subsystem

(75) Inventors: Daniel M. Dreps, Georgetown, TX (US); Frank D. Ferriaolo, New Windsor, NY (US); Kevin C. Gower, LaGrangeville, NY (US); Mark W. Kellogg, Henrietta, NY (US); Roger A. Rippens, Salt Point, NY (US)

Correspondence Address: CANTOR COLBURN LLP-IBM POUGHKEEPSIE, 55 GRIFFIN ROAD SOUTH, BLOOMFIELD, CT, 06002, US

(73) Assignee: International Business Machines Corporation, Armonk, NY (US)

(21) Appl. No.: 10/977,884

(22) Filed: Oct. 29, 2004

(51) Int. Cl. G06F 12/14; G06F 13/00

(52) U.S. Cl. 710/100; 711/100

(57) ABSTRACT

A method for re-driving data in a memory subsystem. The method includes receiving controller interface signals and a forwarded interface clock associated with the controller interface signals at a memory module. The memory module is part of a cascaded interconnect system. The controller interface signals are sampled with the forwarded interface clock and the sampling results in the controller interface signals being latched into interface latches. The controller interface signals are then latched into local latches using a local clock on the memory module. The contents of the local latches along with the local clock are transmitted to an other memory module or controller in the cascaded interconnect system.

### BACKGROUND OF THE INVENTION

The invention relates to a memory subsystem and in particular, to merging local data onto a bus which contains data from other sources.

Computer memory subsystems have evolved over the years, but continue to retain many consistent attributes. Computer memory subsystems from the early 1980's, such as the one disclosed in U.S. Pat. No. 4,475,194 to LaVallee et al., of common assignment herewith, included a memory controller, a memory assembly (contemporarily called a basic storage module (BSM) by the inventors) with array devices, buffers, terminators and ancillary timing and control functions, as well as several point-to-point busses to permit each memory assembly to communicate with the memory controller via its own point-to-point address and data bus. FIG. 1 depicts an example of this early 1980 computer memory subsystem with two BSMs, a memory controller, a maintenance console, and point-to-point address and data busses connecting the BSMs and the memory controller.

FIG. 2, from U.S. Pat. No. 5,513,135 to Dell et al., of common assignment herewith, depicts an early synchronous memory module, which includes synchronous dynamic random access memories (DRAMs) 8, buffer devices 12, an optimized pinout, an interconnect and a capacitive decoupling method to facilitate operation. The patent also describes the use of clock re-drive on the module, using such devices as phase lock loops (PLIs).

FIG. 3, from U.S. Pat. No. 6,510,100 to Grundon et al., of common assignment herewith, depicts a simplified diagram and description of a memory system 10 that includes up to four registered dual inline memory modules (DIMMs) 40 on a traditional multi-drop stub bus channel. The subsystem includes a memory controller 20, an external clock buffer 30, registered DIMMs 40, an address bus 50, a control bus 60 and a data bus 70 with terminators 95 on the address bus 50 and data bus 70.

FIG. 4 depicts a 1990's memory subsystem which evolved from the structure in FIG. 1 and includes a memory controller 402, one or more high speed point-to-point channels 404, each connected to a bus-to-bus converter chip 406, and each having a synchronous memory interface 408 that enables connection to one or more registered DIMMs 410. In this implementation, the high speed, point-to-point channel 404 operated at twice the DRAM data rate, allowing the bus-to-bus converter chip 406 to operate one or two registered DIMM memory channels at the full DRAM data rate. Each registered DIMM included a PLL, registers, DRAMs, an electrically erasable programmable read-only memory (EEPROM) and terminators, in addition to other passive components.

As shown in FIG. 5, memory subsystems were often constructed with a memory controller connected either to a single memory module, or to two or more memory modules interconnected on a ‘stub’ bus. FIG. 5 is a simplified example of a multi-drop stub bus memory structure, similar to the one shown in FIG. 3. This structure offers a reasonable tradeoff between cost, performance, reliability and upgrade capability, but has inherent limits on the number of modules that may be attached to the stub bus. The limit on the number of modules that may be attached to the stub bus is directly related to the data rate of the information transferred over the bus. As data rates increase, the number and length of the stubs must be reduced to ensure robust memory operation. Increasing the speed of the bus generally results in a reduction in modules on the bus with the optimal electrical interface being one in which a single module is directly connected to a single controller, or a point-to-point interface with few, if any, stubs that will result in reflections and impedance discontinuities. As most memory modules are sixty-four or seventy-two bits in data width, this structure also requires a large number of pins to transfer address, command, and data. One hundred and twenty pins are identified in FIG. 5 as being a representative pincount.

FIG. 6, from U.S. Pat. No. 4,723,120 to Petty, of common assignment herewith, is related to the application of a daisy chain structure in a multipoint communication structure that would otherwise require multiple ports, each connected via point-to-point interfaces to separate devices. By adopting a daisy chain structure, the controlling station can be produced with fewer ports (or channels), and each device on the channel can utilize standard upstream and downstream protocols, independent of their location in the daisy chain structure.

FIG. 7 represents a daisy chained memory bus, implemented consistent with the teachings in U.S. Pat. No. 4,723,120. A memory controller 111 is connected to a memory bus 315, which further connects to a module 310a. The information on bus 315 is re-driven by the buffer on module 310a to a next module, 310b, which further re-drives the bus 315 to module positions denoted as 310n. Each module 310a includes a DRAM 311a and a buffer 320a. The bus 315 may be described as having a daisy chain structure with each bus being point-to-point in nature.

One drawback to the use of a daisy chain bus is associated with the capturing and repowering of the signals between the memory modules. In daisy chained memory module structures, the latency of data transmission as it travels between the cascaded memory modules and back to the memory controller is critical to performance. Currently, the merging of local data from a memory module with data from other sources already on the memory bus delays the re-drive of data being transferred on the bus.

### BRIEF SUMMARY OF THE INVENTION

Exemplary embodiments of the present invention include a method for re-driving data in a memory subsystem. The method includes receiving controller interface signals and a forwarded interface clock associated with the controller interface signals at a memory module. The memory module is part of a cascaded interconnect system. The controller interface signals are sampled with the forwarded interface clock and the sampling results in the controller interface signals being latched into interface latches. The controller interface signals are then latched into local latches using a local clock on the memory module. The contents of the local latches along with the local clock are transmitted to an other memory module or controller in the cascaded interconnect system.

Additional exemplary embodiments include a cascaded interconnect system. The system includes a memory controller, a memory bus and one or more memory modules. The memory controller and the memory modules are interconnected by a packetized multi-transfer interface via the memory bus. Each memory module includes interface latches, local latches and a local clock. Each memory module also includes instructions for receiving controller interface signals and a forwarded interface clock associated with the controller interface signals via the memory bus. Instructions are also included for sampling the controller interface signals with the forwarded interface clock, with the sampling resulting in the controller interface signals being latched into the interface latches. Further instructions are included for latching the controller interface signals into the local latches using the local clock and transmitting, via the memory bus, the contents of the local latches along with the local clock to an other memory module or to the controller.

Further exemplary embodiments include a storage medium for re-driving data in a memory subsystem. The storage medium is encoded with machine readable computer program code for causing a computer to implement a method. The method includes receiving controller interface signals and a forwarded interface clock associated with the controller interface signals at a memory module. The memory module is part of a cascaded interconnect system. The controller interface signals are sampled with the forwarded interface clock and the sampling results in the controller interface signals being latched into interface latches. The controller interface signals are then latched into local latches using a local clock on the memory module. The contents of the local latches along with the local clock are transmitted to an other memory module or controller in the cascaded interconnect system.

A further embodiment includes a dual inline memory module (DIMM) including a card and a plurality of individual local memory devices attached to the card. The card has a length of about 151.2 to about 151.5 millimeters and a key. A buffer device is attached to the card, with the buffer device configured for converting a packetized memory interface. The card includes at least 276 pins configured thereon with power pins and ground pins spanning the key.

### BRIEF DESCRIPTION OF THE DRAWINGS

Referring now to the drawings wherein like elements are numbered alike in the several FIGURES:

FIG. 1 depicts a prior art memory controller connected to two buffered memory assemblies via separate point-to-point links;

FIG. 2 depicts a prior art synchronous memory module with a buffer device;

FIG. 3 depicts a prior art memory subsystem using registered DIMMs;

FIG. 4 depicts a prior art memory subsystem with point-to-point channels, registered DIMMs, and a 2:1 bus speed multiplier;

FIG. 5 depicts a prior art memory structure that utilizes a multidrop memory ‘stub’ bus;

FIG. 6 depicts a prior art daisy chain structure in a multipoint communication structure that would otherwise require multiple ports;

FIG. 7 depicts a prior art daisy chain connection between a memory controller and memory modules;

FIG. 8 depicts a cascaded memory structure that is utilized by exemplary embodiments of the present invention;

FIG. 9 depicts a memory structure with cascaded memory modules and unidirectional busses that is utilized by exemplary embodiments of the present invention;

FIG. 10 depicts a buffered module wiring system that is utilized by exemplary embodiments of the present invention;

FIG. 11 depicts a high level view of circuits and functions within a buffer device in accordance with exemplary embodiments of the present invention;

FIG. 12 depicts the circuits that controller interface signals will travel through from the time that they are received by the buffer device until the time that they are driven off the buffer device in exemplary embodiments of the present invention;

FIG. 13 is a front view of a 276-pin, buffered memory module (DIMM) that is utilized by exemplary embodiments of the present invention;

FIG. 14 is a block diagram of a multi-mode buffer device high level logic flow as utilized by exemplary embodiments of the present invention;

FIG. 15 is a table that includes typical applications and operating modes of exemplary buffer devices;

FIG. 16 is a simplified block diagram of a buffered DIMM produced with a multi-mode buffer device that may be utilized by exemplary embodiments of the present invention;

FIG. 17 is a simplified block diagram of a buffered DIMM produced with a multi-mode buffer device that may be utilized by exemplary embodiments of the present invention;

FIG. 18 is a table illustrating a functional pin layout of the exemplary 276-pin DIMM of FIG. 13, in accordance with a further embodiment of the invention; and

FIG. 19 is a table illustrating a functional pin layout of the exemplary 276-pin DIMM of FIG. 13, in accordance with a further embodiment of the invention.

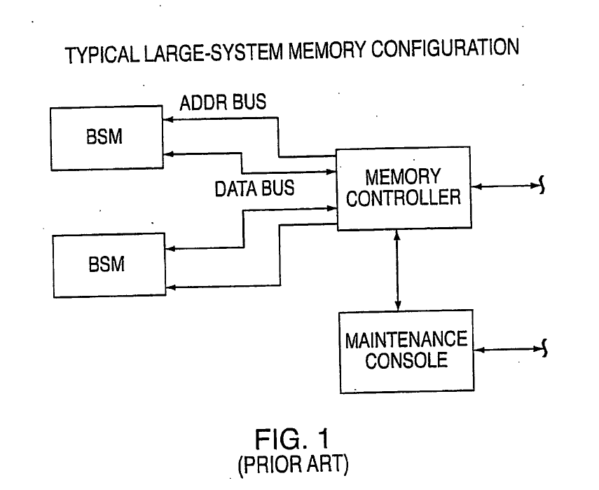

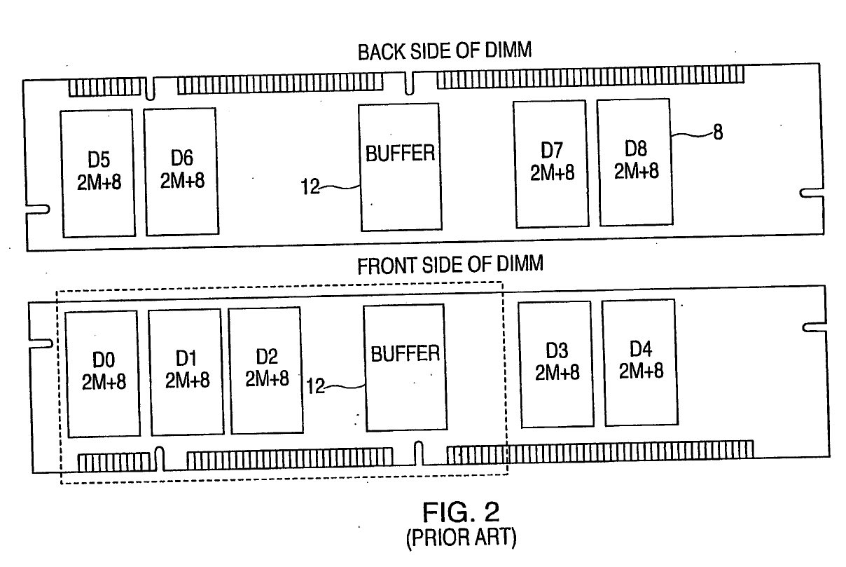

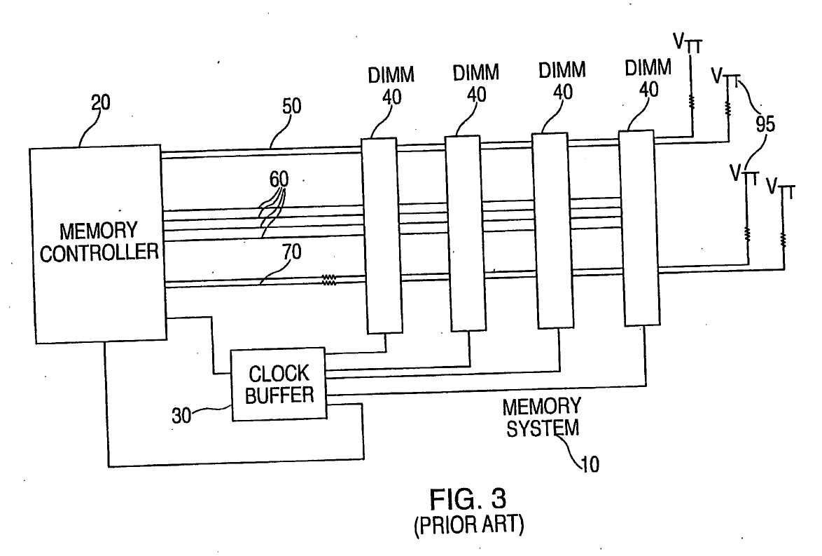

### DETAILED DESCRIPTION OF THE PREFERRED EMBODIMENTS

Exemplary embodiments of the present invention provide circuits and methods of transmitting information in a cascaded memory module structure with high bandwidth and low latency. Memory read operations that access memory modules further away, or downstream, from the memory controller take longer to return data than operations accessing memory modules nearer to the controller. Command information sent from the controller must be captured and re-powered by each of the cascaded memory modules in the channel (or memory bus) as it makes its way to the selected memory module. Further, the returned read data must also travel to and through each of the cascaded memory modules. For this reason, the latency through each individual cascaded controller interface connection is an important component of the overall system performance. A further requirement of the controller interface in a buffered memory module system is that it be capable of merging locally obtained read data into the read data that is received from the downstream memory modules. Merging the downstream read data with the locally obtained read data with a minimum amount of added latency presents a difficult timing problem to solve.

Exemplary embodiments of the present invention include a memory subsystem using cascaded and fully buffered memory modules with controller interfaces to a controller and/or to other memory modules. The memory modules are connected by unidirectional, high speed signaling links referred to as memory busses. Forwarded clocks are utilized to re-drive data along the high speed memory busses. Forwarded clock refers to the data being received on the high speed links (e.g., the memory data busses) along with a clock for sampling the incoming data. The data from the high speed links is then put into the local clock domain and re-driven on the high speed links (upstream or downstream) with the local clock as the forwarded clock for the re-drive. Exemplary embodiments of the controller interfaces utilize single ended, or differential, high speed signaling, forwarded clocks, an elastic interface data capture macro, a phase locked loop (PLL) used to create local clock domains from the forwarded clock, as well as a double data rate (DDR) re-powered signal generator tightly coupled to the incoming data capture circuits. This combination produces an interface with a relatively high bandwidth per pin along with low latency per cascaded memory module.

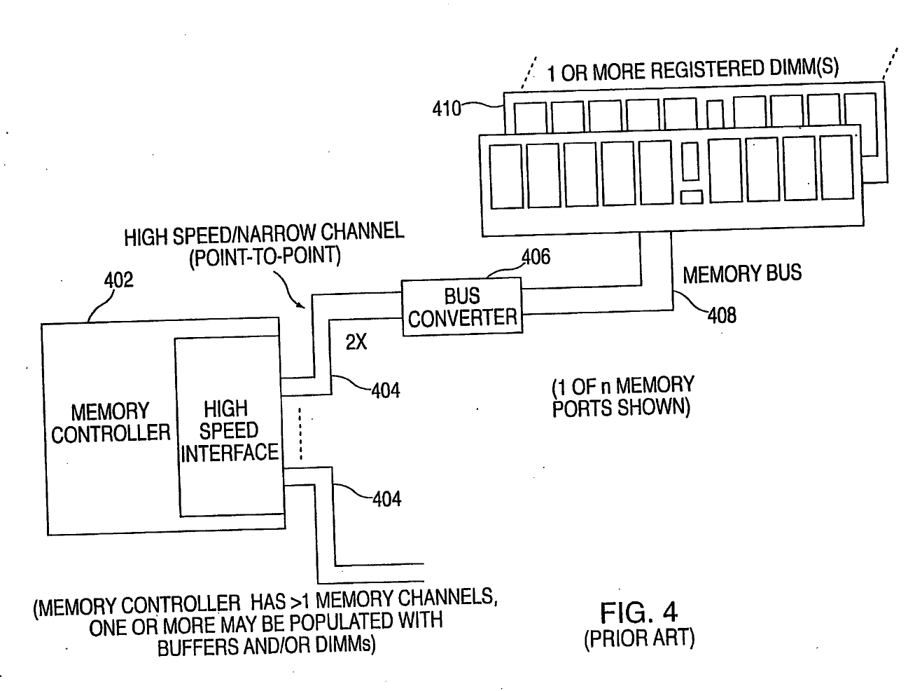

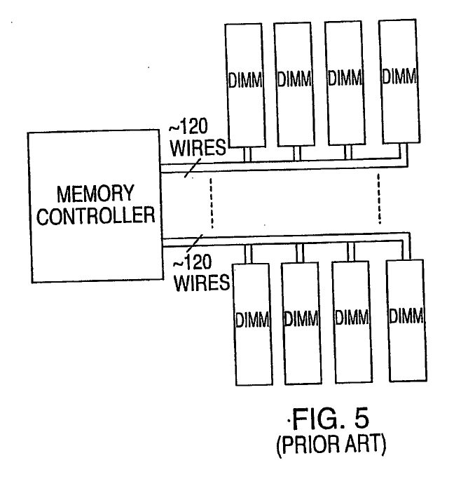

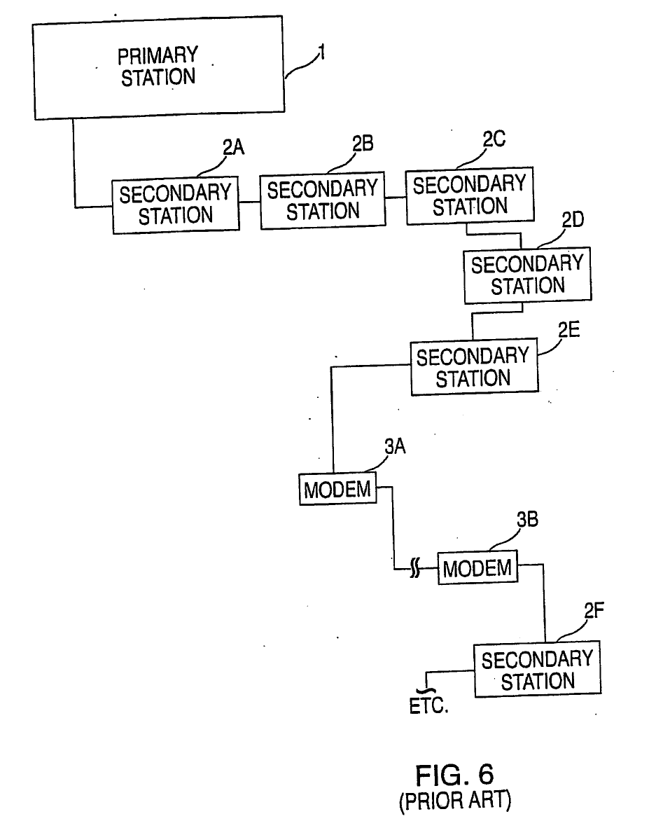

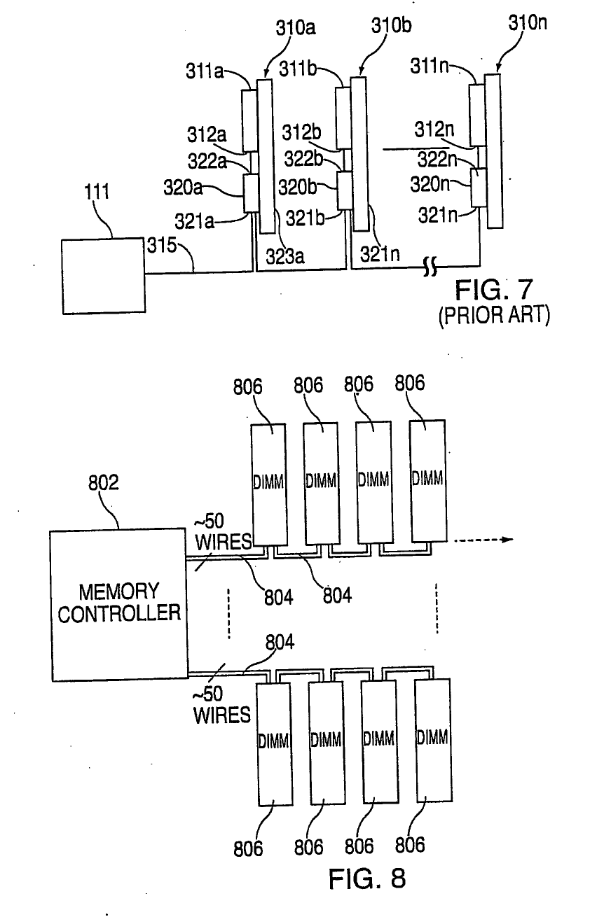

FIG. 8 depicts a cascaded memory structure that may be utilized by exemplary embodiments of the present invention when buffered memory modules 806 (e.g., the buffer device is included within the memory module 806) are in communication with a memory controller 802. This memory structure includes the memory controller 802 in communication with one or more memory modules 806 via a high speed point-to-point bus 804. Each bus 804 in the exemplary embodiment depicted in FIG. 8 includes approximately fifty high speed wires for the transfer of address, command, data and clocks. By using point-to-point busses as described in the aforementioned prior art, it is possible to optimize the bus design to permit significantly increased data rates, as well as to reduce the bus pincount be; transferring data over multiple cycles. Whereas FIG. 4 depicts a memory subsystem with a two to one ratio between the data rate on any one of the busses connecting the memory controller to one of the bus converters (e.g., to 1,066 Mb/s per pin) versus any one of the busses between the bus converter and one or more memory modules (e.g., to 533 Mb/s per pin), an exemplary embodiment of the present invention, as depicted in FIG. 8, provides a four to one bus speed ratio to maximize bus efficiency and to minimize pincount.

Although point-to-point interconnects permit higher data rates, overall memory subsystem efficiency must be achieved by maintaining a reasonable number of memory modules 806 and memory devices per channel (historically four memory modules with four to thirty-six chips per memory module, but as high as eight memory modules per channel and as few as one memory module per channel). Using a point-to-point bus necessitates a bus re-drive function on each memory module to permit memory modules to be cascaded such that each memory module is interconnected to other memory modules, as well as to the memory controller 802.

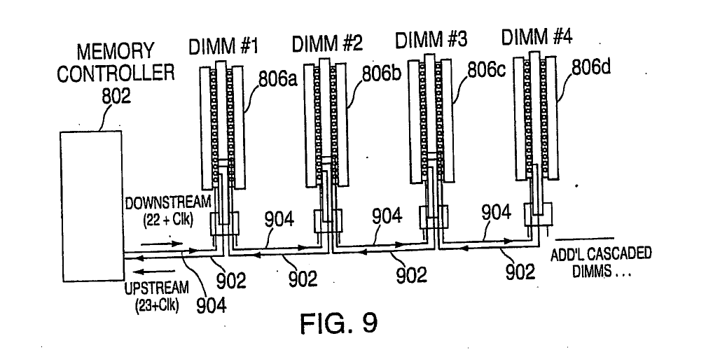

FIG. 9 depicts a memory structure with cascaded memory modules and unidirectional busses that is utilized by exemplary embodiments of the present invention. One of the functions provided toy the memory modules 806 in the cascade structure is a re-drive function to send signals on the memory bus to other memory modules 806 or to the memory controller 802. FIG. 9 includes the memory controller 802 and four memory modules 806a, 806b, 806c and 806d, on each of two memory busses (a downstream memory bus 904 and an upstream memory bus 902), connected to the memory controller 802 in either a direct or cascaded manner. Memory module 806a is connected to the memory controller 802 in a direct manner. Memory modules 806b, 806c and 806d are connected to the memory controller 802 in a cascaded manner.

An exemplary embodiment of the present invention includes two uni-directional busses between the memory controller 802 and memory module 806a (“DIMM #1”), as well as between each successive memory module 806b-d (“DIMM #2”, “DIMM #3” and “DIMM #4”) in the cascaded memory structure. The downstream memory bus 904 is comprised of twenty-two single-ended signals and a differential clock pair. The downstream memory bus 904 is used to transfer address, control, write data and bus-level error code correction (ECC) bits downstream from the memory controller 802, over several clock cycles, to one or more of the memory modules 806 installed on the cascaded memory channel. The upstream memory bus 902 is comprised of twenty-three single-ended signals and a differential clock pair, and is used to transfer read data and bus-level ECC bits upstream from the sourcing memory module 806 to the memory controller 802. Because the upstream memory bus 902 and the downstream memory bus 904 are unidirectional and operate independently, read data, write data and memory commands may be transmitted simultaneously. This increases effective memory subsystem bandwidth and may result in higher system performance. Using this memory structure, and a four to one data rate multiplier between the DRAM data rate (e.g., 400 to 800 Mb/s per pin) and the unidirectional memory bus data rate (e.g., 1.6 to 3.2 Gb/s per pin), the memory controller 802 signal pincount, per memory channel, is reduced from approximately one hundred and twenty pins to about fifty pins.

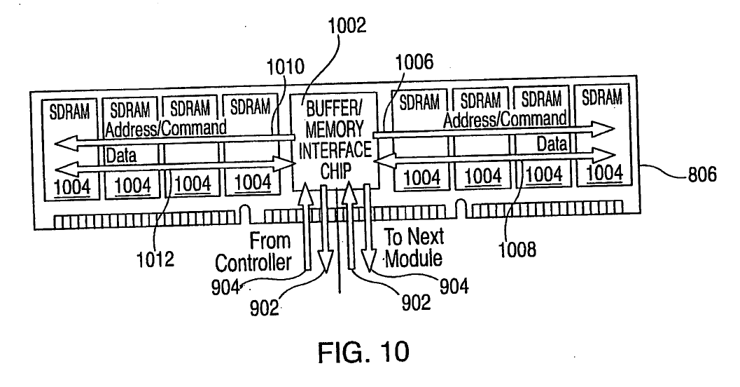

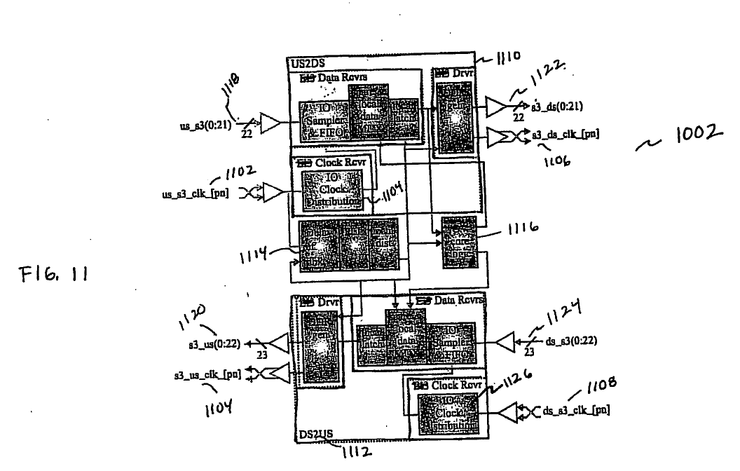

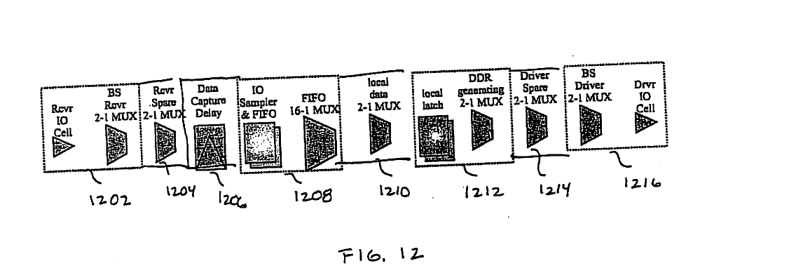

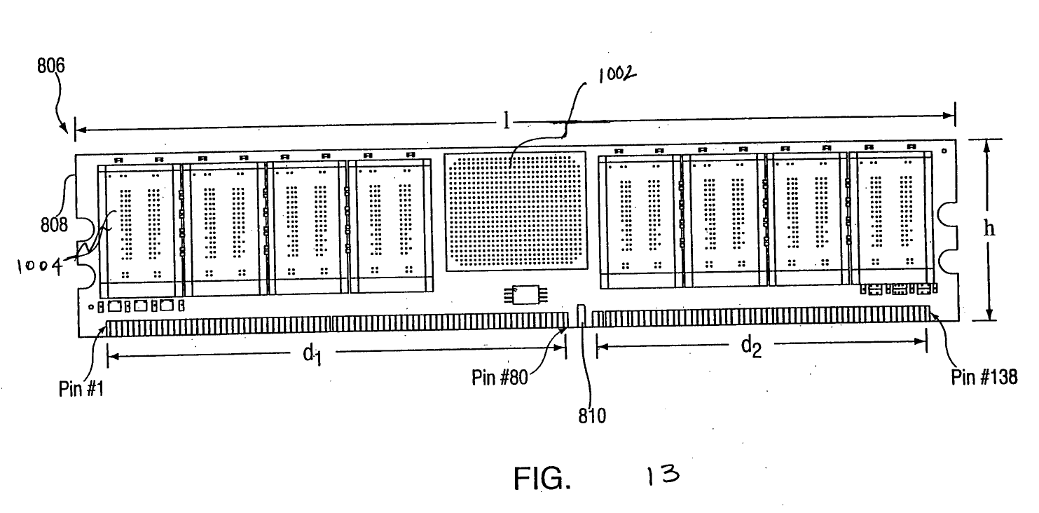

FIG. 10 depicts a buffered module wiring system that is utilized by exemplary embodiments of the present invention. FIG. 10 is a pictorial representation of a memory module with shaded arrows representing the primary signal flows. The signal flows include the upstream memory bus 902, the downstream memory bus 904, memory device address and command busses 1010 and 1006, and memory device data busses 1012 and 1008. In an exemplary embodiment of the present invention, a buffer device 1002, also referred to as a memory interface chip, provides two copies of the address and command signals to the SDRAMs 1004 with the right memory device address and command bus 1006 exiting from the right side of the buffer device 1002 for the SDRAMs 1004 located to the right side and behind the buffer device 1002 on the right. The left memory device address and command bus 1010 exits from the left side of the buffer device 1002 and connects to the SDRAMs 1004 to the left side and behind the buffer device 1002 on the left. Similarly, the data bits intended for SDRAMs 1004 to the right of the buffer device 1002 exit from the right of the buffer device 1002 on the right memory device data bus 1008. The data bits intended for the left side of the buffer device 1002 exit from the left of the buffer device 1002 on the left memory device data bus 1012. The high speed upstream memory bus 902 and downstream memory bus 904 exit from the lower portion of the buffer device 1002, and connect to a memory controller or other memory modules either upstream or downstream of this memory module 806, depending on the application. The buffer device 1002 receives signals that are four times the memory module data rate and converts them into signals at the memory module data rate.

The memory controller 802 interfaces to the memory modules 806 via a pair of high speed busses (or channels). The downstream memory bus 904 (outbound from the memory controller 802) interface has twenty-four pins and the upstream memory bus 902 (inbound to the memory controller 802) interface has twenty-five pins. The high speed channels each include a clock pair (differential), a spare bit lane, ECC syndrome bits and the remainder of the bits pass information (based on the operation underway). Due to the cascaded memory structure, all nets are point-to-point, allowing reliable high-speed communication that is independent of the number of memory modules 806 installed. Whenever a memory module 806 receives a packet on either bus, it re-synchronizes the command to the internal clock and re-drives the command to the next memory module 806 in the chain (if one exists).

As described previously, the memory controller 802 interfaces to the memory module 806 via a pair of high speed channels (i.e., the downstream memory bus 904 and the upstream memory bus 902). The downstream (outbound from the memory controller 802) interface has twenty-four pins and the upstream (inbound to the memory controller 802) has twenty-five pins. The high speed channels each consist of a clock pair (differential), as well as single ended signals. Due to the cascade memory structure, all nets are point to point, allowing reliable high-speed communication that is independent of the number of memory modules 806 installed. The differential clock received from the downstream interface is used as the reference clock for the buffer device PLL and is therefore the source of all local buffer device 1002 clocks. Whenever the memory module 806 receives a packet on either bus, it re-synchronizes it to the local clock and drives it to the next memory module 806 or memory controller 802, in the chain (if one exists).

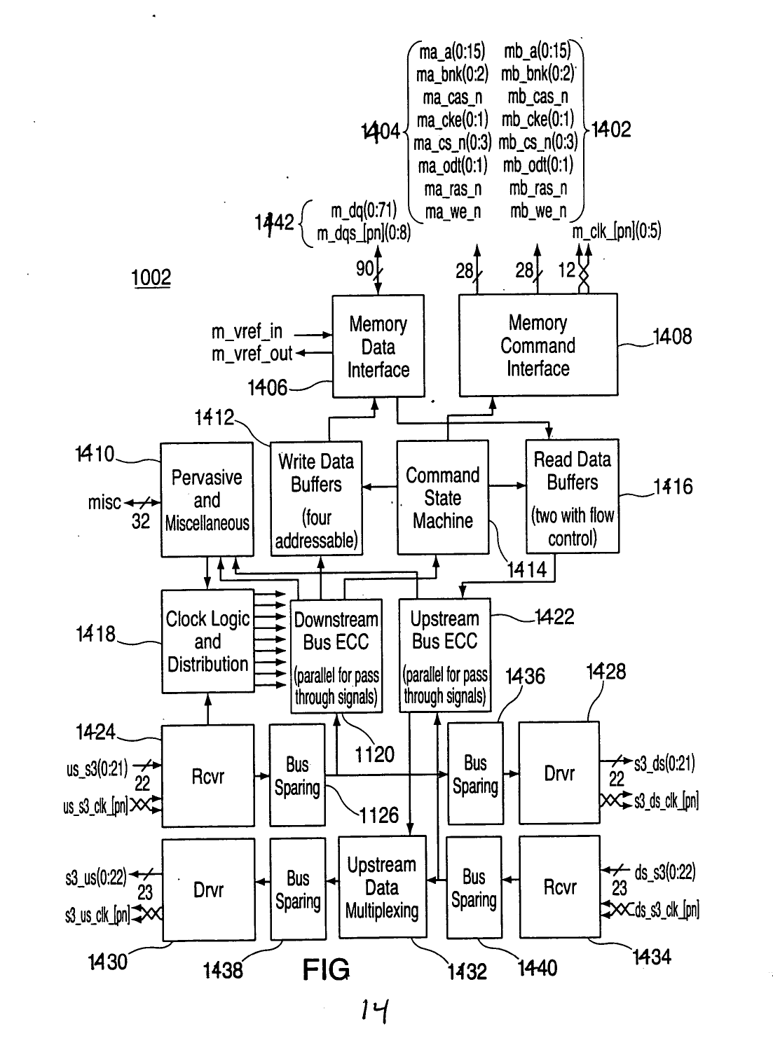

FIG. 11 depicts a high level view of circuits and functions within a buffer device 1002 in accordance with exemplary embodiments of the present invention. The buffer device 1002 is located in the first memory module 806 in a cascaded memory subsystem with two or more memory modules 806, and as such has the memory controller 802 located upstream and another memory module 806 (with the same circuitry depicted in FIG. 11) located downstream. The buffer device includes an upstream to downstream functional block 1110 with data receivers, a driver and a clock receiver. Input to the upstream to downstream functional block 1110 includes controller interface signals 1118 and a controller interface bus clock 1102. The inputs are received via the downstream memory bus 904. Output from the upstream to downstream functional block 1110 includes a controller interface downstream clock signal 1106 and controller interface downstream data signals 1122.

The buffer device 1002 also includes a downstream to upstream functional block 1112 with data receivers and a clock receiver. Input to the downstream to upstream functional block 1112 includes interface signals 1124 and an interface bus clock 1108 via the upstream memory bus 902. Output from the downstream to upstream functional block 1112 includes an interface upstream clock signal 1104 and interface upstream data signals 1120 being sent via the upstream memory bus 902. The interface upstream data signals 1120 include any locally merged read data from the buffer device 1002.

Also included in the buffer device 1002 is a local clock functional block 1114, including delay reference/feedback, PLL and local distribution. The buffer device 1002 further includes a core logic functional block 1116 (contains the memory interface, etc) which is driven off of the local clock.

The buffer device 1002 depicted in FIG. 11 contains three clock domains. The downstream input/output (IO) clock domain includes the “IO Sampler & first in first out (FIFO)” in the upstream to downstream functional block 1110 and the “IO clock distribution” block 1128 in the upstream to downstream functional block 1110. The upstream IO clock domain includes the “IO Sampler & FIFO” in the downstream to upstream functional block 1112 and a “IO clock distribution” block 1126 in the downstream to upstream functional block 1112. The local clock domain includes the remaining blocks in FIG. 11 (i.e., those that are not included in the downstream IO clock domain or the upstream IO clock domain).

The downstream IO clock domain runs off of the controller interface bus clock 1102 (i.e., the forwarded interface clock) from the memory controller 802. The controller interface bus clock 1102 is utilized to latch the controller interface signals 1118 into interface latches in the buffer device 1002. The data is latched into latches by the IO sampler portion of the upstream to downstream functional block 1110 in conjunction with signals from the IO clock distribution block 1128. The FIFO portion of the upstream to downstream functional block 1110 allows the transfer of the latched signals into the local clock domain. The IO clock distribution block 1128 in the upstream to downstream functional block 1110 samples the high speed interface from the memory controller 802. The IO clock distribution block 1128 takes the received controller interface bus clock 1102 (it may condition it to read more reliably) and delivers it to the latches in the IO sampler and FIFO portion of the upstream to downstream functional block 1110. Another function of the controller interface bus clock 1102 is that it is input into the local clock functional block 1114 in the local clock domain.

The local clock domain receives its reference oscillator from the controller interface bus clock 1102 which is input to the local clock functional block 1114. In the local clock functional block 1114, the IO clock may be modified by optional offsetting delay adjustments, passed through a PLL and then distributed as the local clock to all areas of the buffer device 1002 (e.g., to the local latch in the upstream to downstream functional block 1110 and the cure logic functional block 1116) via the local distribution logic. The local clock arrives at the other areas of the buffer device 1002 at the offset delay time due to the feedback and circuits of the PLL. As is known in the art, the PLL is utilized, among other things, to remove the time difference between the controller interface bus clock 1102 and the local clock by using a feedback path from the local distribution to the delay reference block in the local clock functional block 1114. As a result, the local clock is nominally in phase with the controller interface bus clock 1102 but offset by a deterministic amount of delay.

As described previously, the received controller interface bus clock 1102 (i.e., the forwarded clock) is distributed to the “IO sampler” and to the FIFO block in the upstream to downstream functional block 1110. The controller interface signals 1118 are captured there and transferred into the local clock domain in the “spare and local data multiplexor” and “local latch” blocks in the upstream to downstream functional block 1110. Because all signals are transferred into the local clock domain, they can be easily merged with local data sources from the core logic functional block 1116 (e.g., local memory read data). The “DDR generator” block in the upstream to downstream functional block 1110 performs the merge function and then generates DDR signals to be driven out on the controller interface outputs. Both a controller interface downstream clock signal 1106 and controller interface downstream data signals 1122 are transmitted to the next memory module 806 (if any) in the cascaded memory subsystem. The same process, with the exception that the local clock is not driven by the IO clock distribution block 1126 in the downstream to upstream functional block 1112, is performed for data being received by the upstream memory bus 902 (i.e., controller interface signals 1124 and controller interface bus clock 1108).

Because all driven signals (i.e., the controller interface downstream data signals 1122 and the controller interface upstream data signals 1120) are launched from latches in the local clock domain, their clocks have been cleaned up by the PLL in the buffer device 1002. This allows high bandwidth signaling by preventing accumulated noise effects, such as duty cycle distortion and jitter, from building up on the cascaded controller interfaces. Forwarded clocks allow high speed operation with a simple clock recovery mechanism.

Local data merging is accomplished by selecting between controller interface signals 1124 that are ready to be captured in the local clock domain and local data from the core logic functional block 1116. The selection is possible because both the data that came in on the controller interface signals 1124 and the local data are in the local clock domain (i.e., share the same local clock). To minimize latency, local data is given priority at the selector (i.e., the DDR generator in the downstream to upstream functional block 1112). Any non-local data arriving during a cycle in which local data is being driven will be lost. Collisions at the multiplexor are managed by the system memory controller 802 which schedules read data operations to avoid such conflicts. Except for the small gate delay added by the local data multiplexor, the data merging is performed without delaying the re-drive of data being transferred on the bus.

The memory module 806 depicted in FIG. 11 is the first memory module 806 in a cascaded chain of one or more memory modules 806. As such it receives the controller interface signals 1118 and the controller interface bus clock 1102 directly from the controller via the downstream memory bus 904. Memory modules further down the chain (if any) would receive the controller interface signals 1118 and the controller interface bus clock 1102 from the previous memory module 806 in the chain. The logic and circuitry described in reference to FIG. 11 are included in each memory module 806 in the chain of cascaded memory modules 806.

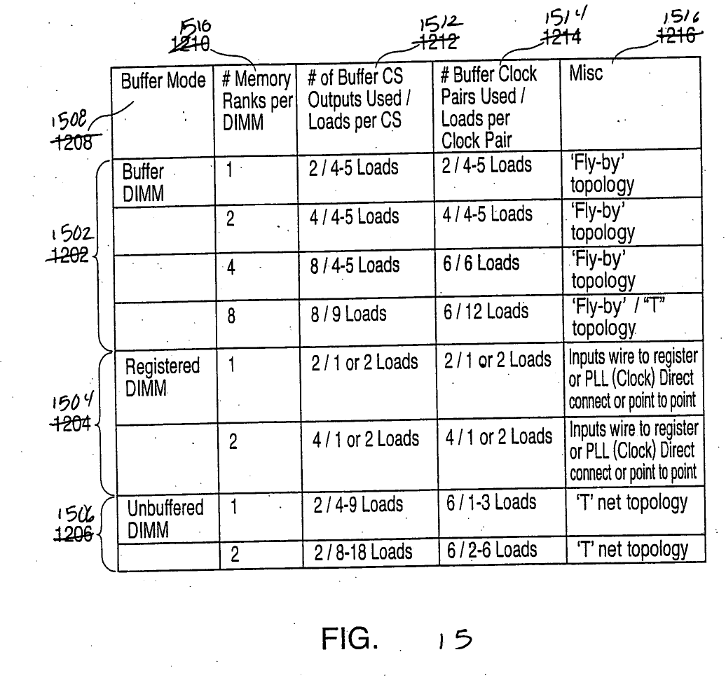

FIG. 12 depicts the circuitry that controller interface signals 1118 will travel through from the time that they are received by the buffer device 1002 (via the upstream data bus 902 or the downstream data bus 904) until the time that they are driven off the buffer device 1002. The controller interface signals are 1118 are received with boundary scan test capability at box 1202; multiplexed with an optional spare receiver signal lane at box 1204; de-skewed by a delay line at box 1206; sampled and de-serialized into a single data rate (SDR) data FIFO until the configured capture time at box 1208; multiplexed with local data at box 1210, latched and re-serialized into DDR data at box 1212, multiplexed with an optional spare driver signal lane at box 1214; and finally, driven off the buffer device 1002 with circuit supporting boundary scan test capability at box 1216.

Exemplary embodiments of the present invention provide the ability for a buffer device on a memory module 806 to merge local data from memory devices on the memory module 806 onto a data bus in a cascaded memory subsystem. The data bus may already contain data from memory devices that are not located on the current memory module 806 for merging with the local data. The merging is performed without delaying the re-drive of data being transferred on the bus. In addition, exemplary embodiments of the present invention sample incoming data with a forwarded bus clock associated with the incoming data and then move the incoming data into a local clock domain. The incoming data is then transmitted to the next memory module in the chain in response to the local clock and the local clock is transmitted as the forward bus clock along with the data. In this manner the clock signals are corrected (e.g., for jitter and duty cycle distortion) between each transmission and may result in better clock signals.

Exemplary embodiments of the present invention include a flexible, high speed and high reliability memory system architecture and interconnect structure that includes a single-ended point-to-point interconnection between any two high speed communication interfaces. The memory subsystem may be implemented in one of several structures, depending on desired attributes such as reliability, performance, density, space, cost, component re-use and other elements. A bus-to-bus converter chip enables this flexibility through the inclusion of multiple, selectable memory interface modes. This maximizes the flexibility of the system designers in defining optimal solutions for each installation, while minimizing product development costs and maximizing economies of scale through the use of a common device. In addition, exemplary embodiments of the present invention provide a migration path that allows an installation to implement a mix of buffered memory modules and unbuffered and/or registered memory modules from a common buffer device.

Memory subsystems may utilize a buffer device to support buffered memory modules (directly connected to a memory controller via a packetized, multi-transfer interfaces with enhanced reliability features) and/or existing unbuffered or registered memory modules (in conjunction with the identical buffer device, on an equivalent but, programmed to operate in a manner consistent with the memory interface defined for those module types). A memory subsystem may communicate with buffered memory modules at one speed and with unbuffered and registered memory modules at another speed (typically a slower speed). Many attributes associated with the buffered module structure are maintained, including the enhanced high speed bus error detection and correction features and the memory cascade function. However, overall performance may be reduced when communicating with most registered and unbuffered DIMMs due to the net topologies and loadings associated with them.

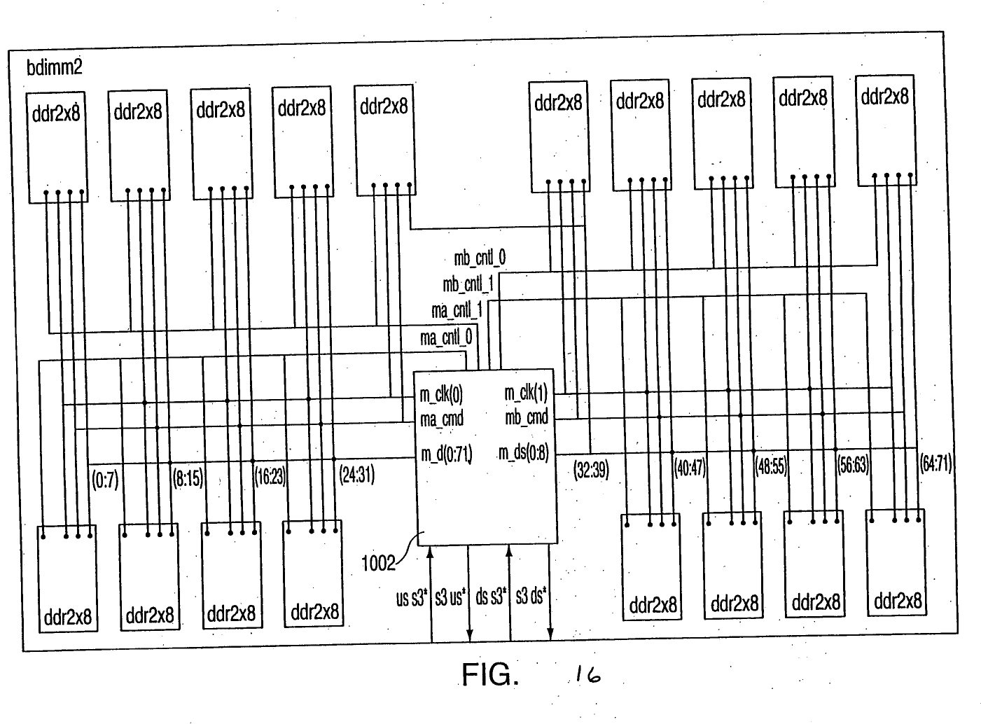

FIG. 13 depicts a buffered memory module 806 that is utilized by exemplary embodiments of the present invention. In exemplary embodiments of the present invention, each memory module 806 includes a blank card having dimensions of approximately six inches long by one and a half inches tall, eighteen DRAM positions, a multi-mode buffer device 1002, and numerous small components as known in the art that are not shown (e.g., capacitors, resistors, EEPROM.) In an exemplary embodiment of the present invention, the dimension of the card is 5.97 inches long by 1.2 inches tall. In an exemplary embodiment of the present invention, the multi-mode buffer device 1002 is located in the center region of the front side of the memory module 806. The synchronous DRAMS (SDRAMS) 1004 are located on either side of the multi-mode buffer device 1002, as well as on the backside of the memory module 806. The configuration may be utilized to facilitate high speed wiring to the multi-mode buffer device 1002 as well as signals from the buffer device to the SDRAMs 1004.

The DRAM package outline is a combination of a tall/narrow (i.e., rectangular) DRAM package and a short/wide (i.e., squarish) DRAM package. Thus configured, a single card design may accommodate either “tall” or “wide” DRAM device/package combinations, consistent with historical and projected device trends. Moreover, the buffer device 1002 is rectangular in shape, thereby permitting a minimum distance between high-speed package interconnects and the DIMM tab pins, as well as reducing the distance the high-speed signals must travel under the package to reach an available high-speed pin, when an optimal ground referencing structure is used.

As is also shown in FIG. 13, the location of a positioning key 810 (notch) is specifically shifted from the midpoint of the length, l, of the card 808 (with respect to prior generation models) in order to ensure the DIMM cannot be fully inserted into a connector intended for a different module type. In addition, the positioning key location also prevents reverse insertion of the DIMM, and allows for a visual aid to the end-user regarding proper DIMM insertion. In the example illustrated, the positioning key 810 is located between pins 80/218 and 81/219. As such, the distance d₁ along the length, l, of the card 808 is larger than the distance d₂.

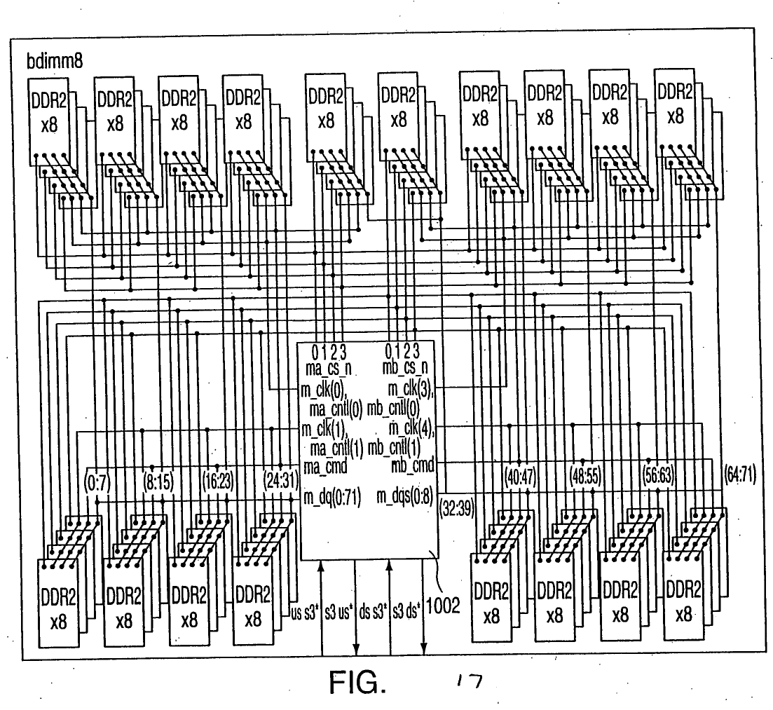

FIG. 14 is a block diagram of the high level logic flow of a multi-mode buffer device 1002 utilized by exemplary embodiments of the present invention. The multi-mode multi-mode buffer device 1002 may be located on a memory module 806 as described previously and/or located on a system board or card to communicate with unbuffered and registered memory modules. The blocks in the lower left and right portions of the drawing (1424, 1428, 1430, 1434) are associated with receiving or driving the high speed bus 804. “Upstream” refers to the bus 902 passing information in the direction of the memory controller 802, and “downstream” refers to the bus 904 passing information away from the memory controller 802.

Referring to FIG. 14, data, command, address, ECC, and clock signals from an upstream memory assembly (i.e., a memory module 806) or a memory controller 802 are received from the downstream memory bus 904 into a receiver module 1424. The receiver functional block 1424 provides macros and support logic for the downstream memory bus 904 and, in an exemplary embodiment of the present invention includes support for a twenty-two bit, high speed, slave receiver bus. The receiver functional block 1424 transmits the clock signals to a clock logic and distribution functional block 1418 (e.g., to generate the four to one clock signals). The clock logic and distribution functional block 1418 also receives data input from the pervasive and miscellaneous signals 1410. These signals typically include control and setup information for the clock distriubtion PLL's, test inputs for BIST (built-in self-test) modes, programmable timing settings, etc. The receiver functional block 1424 transfers the data, command, ECC and address signals to a bus sparing logic block 1426 to reposition, when applicable, the bit placement of the data in the event that a spare wire utilized during the transmission from the previous memory assembly. In an exemplary embodiment of the present invention, the bus sparing logic block 1426 is implemented by a multiplexor to shift the signal positions, if needed. Next, the original or re-ordered signals are input to another bus sparing logic block 1436 to modify, or reorder if necessary, the signal placement to account for any defective interconnect that may exist between the current memory assembly and a downstream memory assembly. The original or re-ordered signals are then input to a driver functional block 1428 for transmission, via the downstream memory bus 904, to the next memory module 806 in the chain. In an exemplary embodiment of the present invention, the bus sparing logic 1436 is implemented using a multiplexor. The driver functional block 1428 provides macros and support logic for the downstream memory bus 904 and, in an exemplary embodiment of the present invention, includes support for the twenty-two bit, high speed, low latency cascade bus drivers.

In addition to inputting the original or re-ordered signals to the bus sparing logic 1436, the bus sparing logic 1426 also inputs the original or re-ordered signals into a downstream bus ECC functional block 1420 to perform error detection and correction for the frame. The downstream bus ECC functional block 1420 operates on any information received or passed through the multi-mode buffer device 1002 from the downstream memory bus 904 to determine if a bus error is present. The downstream bus ECC functional block 1420 analyzes the bus signals to determine if it they are valid. Next, the downstream bus ECC functional block 1420 transfers the corrected signals to a command state machine 1414. The command state machine 1414 inputs the error flags associated with command decodes or conflicts to a pervasive and miscellaneous functional block 1410. The downstream and upstream modules also present error flags and/or error data (if any) to the pervasive and miscellaneous functional block 1410 to enable reporting of these errors to the memory controller, processor, service processor or other error management unit.

Referring to FIG. 14, the pervasive and miscellaneous functional block 1410 transmits error flags and/or error data to the memory controller 802. By collecting error flags and/or error data from each memory module 806 in the chain, the memory controller 802 will be able to identify the failing segment(s), without having to initiate further diagnostics, though additional diagnostics may be completed in some embodiments of the design. In addition, once an installation selected threshold (e.g., one, two, ten, or twenty) for the number of failures or type of failures has been reached, the pervasive and miscellaneous functional block 1410, generally in response to inputs from the memory controller 802, may substitute the spare wire for the segment that is failing. In an exemplary embodiment of the present invention, error detection and correction is performed for every group of four transfers, thereby permitting operations to be decoded and initiated after half of the eight transfers, comprising a frame, are received. The error detection and correction is performed for all signals that pass through the memory module 806 from the downstream memory bus 904, regardless of whether the signals are to be processed by the particular memory module 806. The data bits from the corrected signals are input to the write data buffers 1412 by the downstream bus ECC functional block 1420.

The command state machine 1414 also determines if the corrected signals (including data, command and address signals) are directed to and should be processed by the memory module 806. If the corrected signals are directed to the memory module 806, then the command state machine 1414 determines what actions to take and may initiate DRAM action, write buffer actions, read buffer actions or a combination thereof. Depending on the type of memory module 806 (buffered, unbuffered, registered), the command state machine 1414 selects the appropriate drive characteristics, timings and timing relationships. The write data buffers 1412 transmit the data signals to a memory data interface 1406 and the command state machine 1414 transmits the associated addresses and command signals to a memory command interface 1408, consistent with the DRAM specification. The memory data interface 1406 reads from and writes memory data 1442 to a memory device.

Data signals to be transmitted to the memory controller 802 may be temporarily stored in the read data buffers 1416 after a command, such as a read command, has been executed by the memory module 806, consistent with the memory device ‘read’ timings. The read data buffers 1416 transfer the read data into an upstream bus ECC functional block 1422. The upstream bus ECC functional block 1422 generates check bits for the signals in the read data buffers 1416. The check bits and signals from the read data buffers 1416 are input to the upstream data multiplexing functional block 1432. The upstream data multiplexing functional block 1432 merges the data on to the upstream memory bus 902 via the bus sparing logic 1438 and the driver functional block 1430. If needed, the bus sparing logic 1438 may re-direct the signals to account for a defective segment between the current memory module 806 and the upstream receiving module (or memory controller). The driver functional block 1430 transmits the original or re-ordered signals, via the upstream memory bus 902, to the next memory assembly (i.e., memory module 806) or memory controller 802 in the chain. In an exemplary embodiment of the present invention, the bus sparing logic 1438 is implemented using a multiplexor to shift the signals. The driver functional block 1430 provides macros and support logic for the upstream memory bus 902 and, in an exemplary embodiment of the present invention, includes support for a twenty-three bit, high speed, low latency cascade driver bus.

Data, clock and ECC signals from the upstream memory bus 902 are also received by any upstream multi-mode buffer device 1002 in any upstream memory module 806. These signals need to be passed upstream to the next memory module 806 or to the memory controller 802. Referring to FIG. 14, data, ECC and clock signals from a downstream memory assembly (i.e., a memory module 806) are received on the upstream memory bus 902 into a receiver functional block 1434. The receiver functional block 1434 provides macros and support logic for the upstream memory bus 902 and, in an exemplary embodiment of the present invention includes support for a twenty-three bit, high speed, slave receiver bus. The receiver functional block 1434 passes the data and ECC signals, through the bus sparing functional block 1440, to the upstream data multiplexing functional block 1432 and then to the bus sparing logic block 1438. The signals are transmitted to the upstream memory bus 902 via the driver functional block 1430.

In addition to passing the data and ECC signals to the upstream data multiplexing functional block 1432, the bus sparing functional block 1440 also inputs the original or re-ordered data and ECC signals to the upstream bus ECC functional block 1422 to perform error detection and correction for the frame. The upstream bus ECC functional block 1422 operates on any information received or passed through the multi-mode buffer device 1002 from the upstream memory bus 902 to determine if a bus error is present. The upstream bus ECC functional block 1422 analyzes the data and ECC signals to determine if they are valid. Next, the upstream bus ECC functional block 1422 transfers any error flags and/or error data to the pervasive and miscellaneous functional block 1410 for transmission to the memory controller 802. In addition, once a pre-defined threshold for the number or type of failures has been reached, the pervasive and miscellaneous functional block 1410, generally in response to direction of the memory controller 802, may substitute the spare segment for a failing segment.

The block diagram in FIG. 14 is one implementation of a multi-mode buffer device 1002 that may be utilized by exemplary embodiments of the present invention. Other implementations are possible without departing from the scope of the present invention.

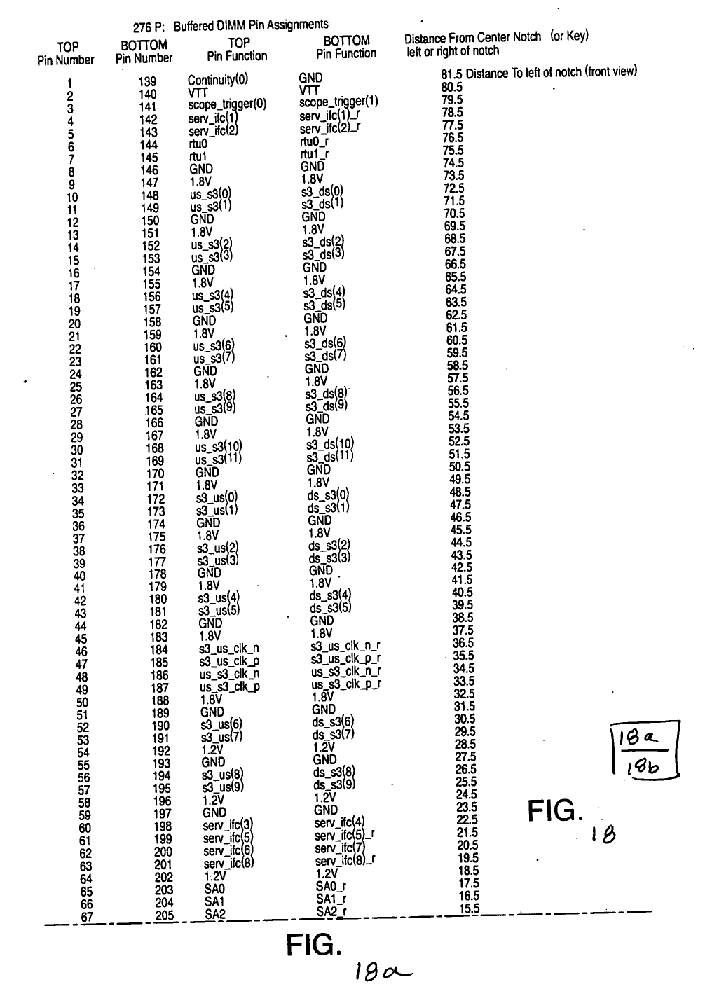

FIG. 15 is a table that includes typical applications and operating modes of exemplary buffer devices. Three types of buffer modes 1508 are described: buffered DIMM 1502; registered DIMM 1504; and unbuffered DIMM 1506. The “a” and “b” bus that are output from the memory command interface 1408 can be logically configured to operate in one or more of these modes depending on the application. The table includes: a ranks column 1510 that contains the number of ranks per DIMM; a chip select (CS) column that contains the number of buffer CS outputs used, in addition to the loads per CS; a clock column 1514 that contains the number of buffer clock pairs used and the loads per clock pair; and a miscellaneous column 1516 that includes wiring topology information. A load refers to a receiver input to a DRAM, register, buffer, PLL or appropriate device on the memory module 806.

As indicated in FIG. 15, the buffered DIMM implementation supports up to nine memory devices per rank, with each device having an eight bit interface (seventy-two bits total). If all eight ranks are populated on a given module constructed of current one gigabit devices, the total memory density of the module will be eight gigabytes. As evident by the table entries under the CS column 1512 (the CS is generally utilized on DIMMs as a rank select to activate all the memory devices in the rank) and the clock column 1514, the varying loads and net structures require different driver characteristics (e.g., drive strength) for the multi-mode buffer device 1002. In addition, as the registered DIMMs generally add a single clock delay on all inputs that pass through the register on the DIMM (address and command inputs), the multi-mode buffer device 1002 needs to accommodate the extra clock of latency by ensuring accurate address and command-to-data timings. Further, the unbuffered DIMMs, as well as the heavily loaded buffered DIMM applications often require two-transition (2T) addressing, due to heavy loading on address and certain command lines (such as row address strobe (RAS), column address strobe (CAS) and write enable (WE)). In the latter case, the buffer operates such that these outputs are allowed two clock cycles to achieve and maintain a valid level prior to the CS pin being driven low to capture these DRAM inputs and initiate a new action.

The terms “net topology” in FIG. 15 refer to a drawing and/or textual description of a wiring interconnect structure between two or more devices. A “fly-by-topology” is a wiring interconnect structure in which the source (driver) is connected to two or more devices that are connected along the length of a wire, that is generally terminated at the far end, where the devices along the wire receive the signal from the source at a time that is based on the flight time through the wire and the distance from the source. A “I” net topology is a wiring interconnect structure that includes a source (driver) that is connected to two or more devices through a wire that branches or splits. Each branch or split is intended to contain similar wire length and loading. In general, a single wire will split into two branches from a single branch point, with each branch containing similar line length and loading. Inputs wired to a single register or clock are generally considered to be point-to-point. Inputs wired to multiple registers or PLLs are generally wired in a “T” net structure so that each receiver receives the input at approximately the same time, with a similar waveform. The “T” nets defined above are typically not end-terminated, but generally include a series resistor termination in the wire segment prior to the branch point.

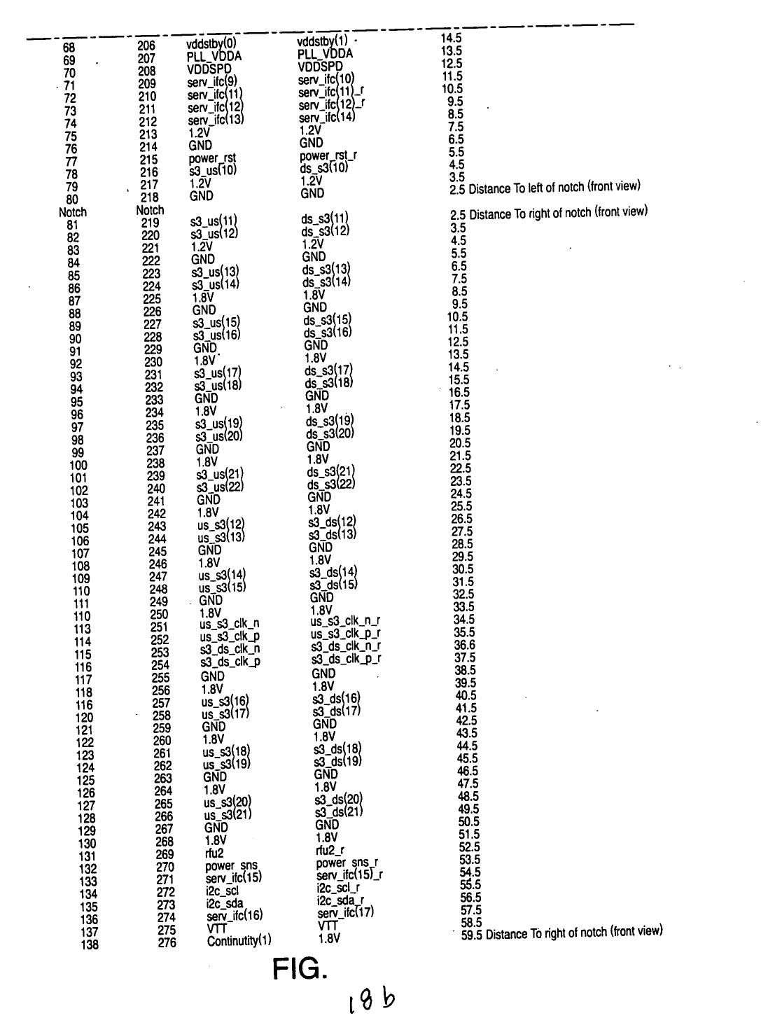

FIG. 16 is a simplified block diagram of a buffered DIMM memory module with the multi-mode buffer device 1002 that may be utilized by exemplary embodiments of the present invention. It provides an example of the net structures and loading associated with a two rank buffered DIMM produced with eighteen DDR2 eight bit memory devices, consistent with the information in the table in FIG. 15. The CS and clock signals are wired in a fly-by structure, the lines shown in the drawing from the mainline wire to each memory device appear to be long only to simplify the drawing. The fly-by net end-termination is not shown, but is included in the exemplary embodiment.

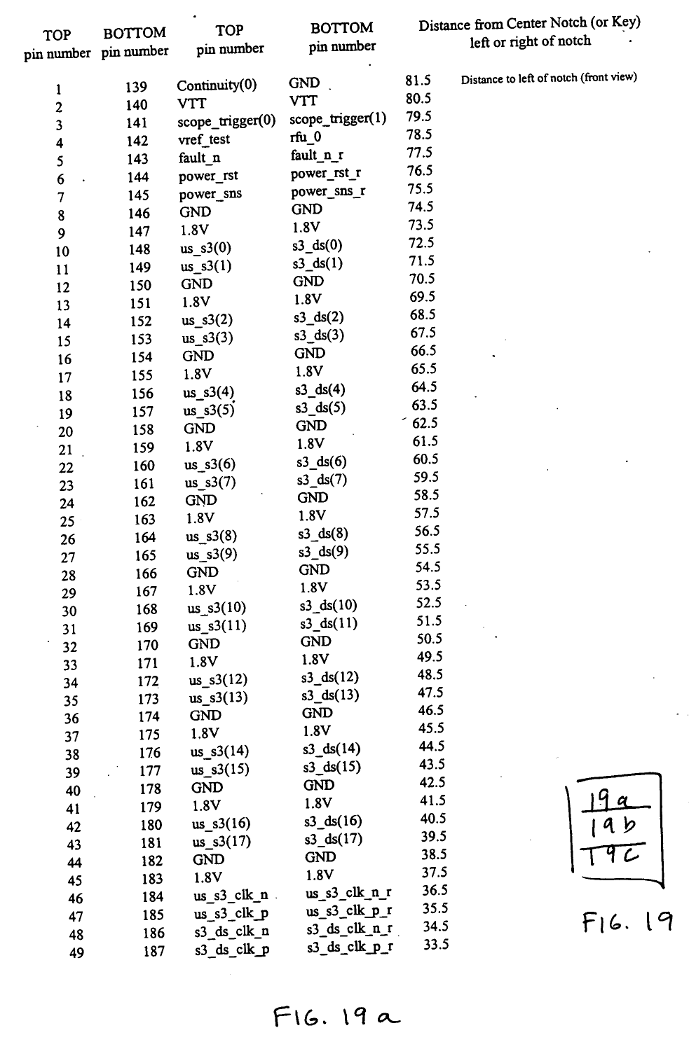

FIG. 17 is a simplified block diagram of a buffered DIMM memory module 806 produced with a multi-mode buffer device 1002 that may be utilized by exemplary embodiments of the present invention. It provides an example of the net structures and loading associated with an eight rank buffered DIMM memory module 806 produced with eight bit memory devices, consistent with the information in the table in FIG. 15. Each CS output controls nine memory devices (seventy-two bits) in this example, whereas each CS controls four or five (thirty-two to forty bits) in FIG. 16.

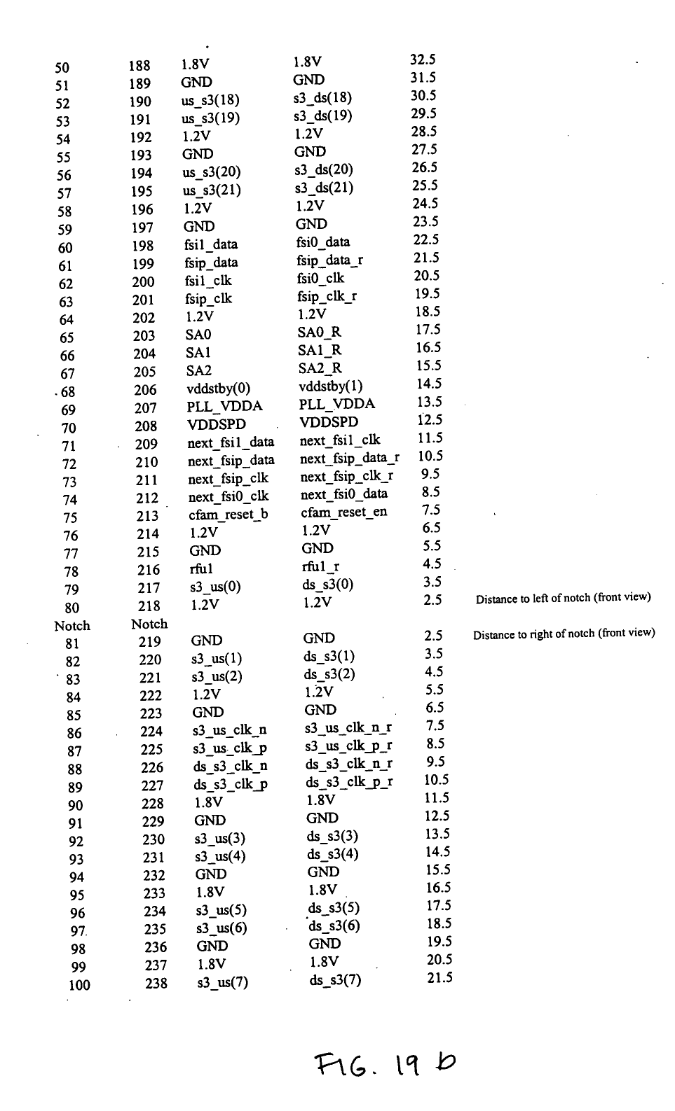

FIG. 18 is a table illustrating a functional pin layout of the exemplary 276-pin DIMM of FIG. 13, in accordance with a further embodiment of the invention. In addition to the layout and approximate distance (millimeters) from the key of each pin, FIG. 18 also provides a functional description of each of the pins, including those used as redundant pins and those used for special control functions. Those pins that are used as redundant pins are designated in FIG. 18 using the suffix “_r”. As indicated previously, designated pins 1-138 run from left to right on the front side of the DIMM, with pins 139-276 located behind pins 1-138 when viewing the front side of the DIMM.

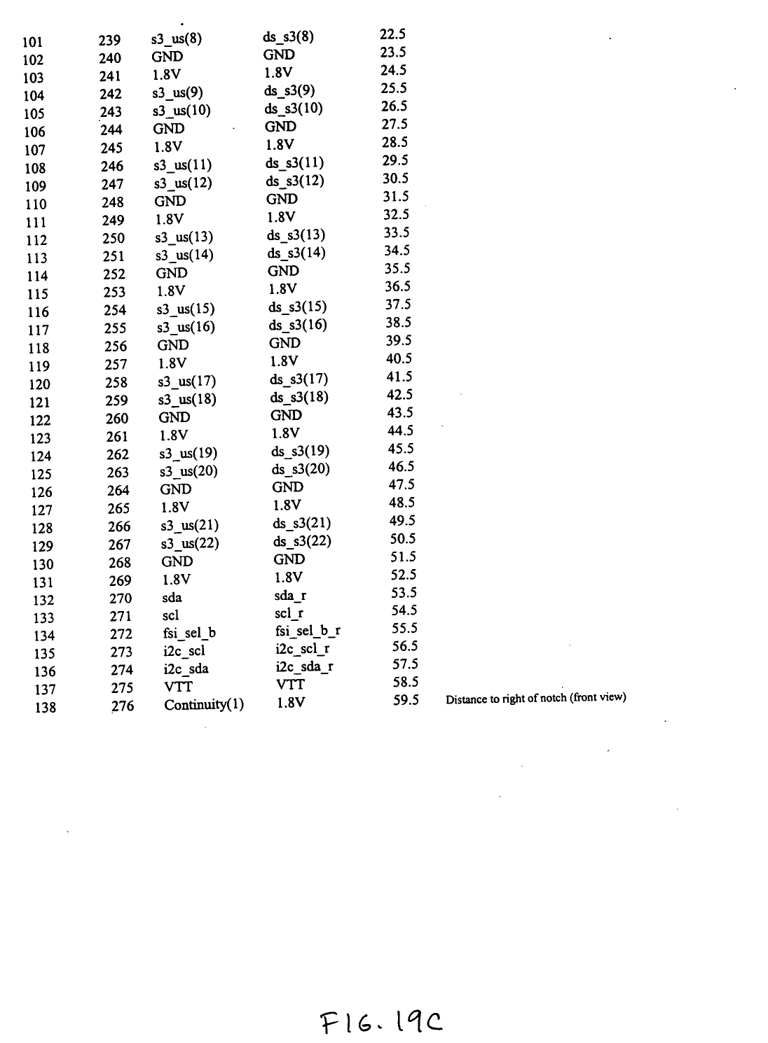

Finally, FIG. 19 is a table illustrating a functional pin layout of the exemplary 276-pin DIMM of FIG. 13, in accordance with a further embodiment of the invention. In addition to the layout and approximate distance (millimeters) from the key of each pin, FIG. 19 also provides a functional description of each of the pins, including those used as redundant pins and those used for special control functions. Those pins that are used as redundant pins are designated in FIG. 19 using the suffix “_r”. As indicated previously, designated pins 1-138 run from left to right on the front side of the DIM, with pins 139-276 located behind pins 1-138 when viewing the front side of the DIMM. In the layout depicted in FIG. 19 spans the key with ground/power tabs which may provide better isolation and/or coupled noise control.

In an exemplary embodiment, each of the redundant pins is located behind the respective primary function pin for which it is redundant. For example, redundant service pins serv_ifc(1)_r and serv_ifc(2)_r (pins 142, 143) are located directly behind service pins serv_ifc(1) and serv_ifc(2) (pins 4, 5), respectively. In this manner, the DIMM is resistant to single point-of-fail memory outage (e.g., such as if the DIMM were warped or tilted toward one side or the other).

Among the various functions included within the 276-pin layout are a pair of continuity pins (1, 138) and scope trigger pins (3, 141). As will be appreciated from an inspection of the pin assignment tables in FIGS. 18 and 19, as opposed to arranging the pins in a conventional layout (where each group of similarly functioning pins are located in the same section of the DIMM), the present embodiment uses an innovative placement wherein the center region is used for two of the four high-speed busses (s3_us, Output: DIMM to upstream DIMM or to Memory Controller) and (ds_s3, DIMM to upstream DIMM (input)). The other two high-speed busses are each split in half, wherein half of each bus (us_s3, controller or DIMM to DIMM (input) and s3_ds, DIMM to downstream DIMM (output)), with approximately half the signals for each bus placed on either end of the center region pin locations. With the buffer device placed close to the center of the module, the variability in wiring length for each pin in both the center and outer regions may be reduced.

As will also be noted, for example in FIG. 18, the pin layout provides for power at both a first voltage level (e.g., 1.8 volts) and a second voltage level (e.g., 1.2 volts, as shown at pins 75, 213, 79, 217). In this manner, the logic portion of the system may be operated independent of and/or prior to powering up the main memory portion of the system, thereby providing additional system memory usage flexibility and/or power savings.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for re-driving data in a memory subsystem, the method comprising:
receiving controller interface signals and a forwarded interface clock that travels associated with the controller interface signals at a memory module that is part of a cascaded interconnect system;
sampling the controller interface signals with the forwarded interface clock, the sampling resulting in the controller interface signals being latched into interface latches;
latching the sampled controller interface signals into local latches using a local clock on the memory module; and
transmitting the contents of the local latches along with the local clock to an other memory module or controller in the cascaded interconnect system.

2. The method of claim 1 further comprising:
generating local data at the memory module; and
merging the local data with the contents of the local latches, wherein the local data is transmitted along with the contents of the local latches and the local clock.

3. The method of claim 1 wherein the local clock receives a reference oscillator from the forwarded interface clock.

4. The method of claim 1 wherein the local clock is created by adding a deterministic delay and applying a phased locked loop to the forwarded interface clock.

5. The method of claim 1 where the receiving and transmitting are via a unidirectional memory bus.

6. The method of claim 5 wherein the memory bus is an upstream memory bus.

7. The method of claim 5 wherein the memory bus is a downstream memory bus.

8. A cascaded interconnect system comprising:
a memory controller;
a memory bus; and
one or more memory modules, wherein the memory controller and the memory modules are interconnected by a packetized multi-transfer interface via the memory bus and each memory module includes interface latches, local latches, a local clock and instructions for:
receiving controller interface signals and a forwarded interface clock that travels associated with the controller interface signals via the memory bus;
sampling the controller interface signals with the forwarded interface clock, the sampling resulting in the controller interface signals being latched into the interface latches;
latching the sampled controller interface signals into the local latches using the local clock; and
transmitting via the memory bus the contents of the local latches along with the local clock to an other memory module or to the controller.

9. The system of claim 8 wherein each memory module includes further instructions for:
generating local data at the memory module; and
merging the local data with the contents of the local latches, wherein the local data is transmitted along with the contents of the local latches and the local clock.

10. The system of claim 8 wherein the local clock receives a reference oscillator from the forwarded interface clock.

11. The system of claim 8 wherein the local clock is created by adding a deterministic delay and applying a phased locked loop to the forwarded interface clock.

12. The system of claim 8 wherein the memory bus is a unidirection memory bus.

13. The system of claim 12 wherein the memory bus is an upstream memory bus.

14. The system of claim 12 wherein the memory bus is a downstream memory bus.

15. The system of claim 8 wherein the instructions are implemented by circuitry.

16. The system of claim 8 wherein the instructions are implemented by software.

17. A storage medium encoded with machine readable computer program code for re-driving data in a memory subsystem, the storage medium including instruction for causing a computer to implement a method comprising:
receiving controller interface signals and a forwarded interface clock that travels associated with the controller interface signals at a memory module that is part of a cascaded interconnect system;
sampling the controller interface signals with the forwarded interface clock, the sampling resulting in the controller interface signals being latched into interface latches;
latching the sampled controller interface signals into local latches using a local clock on the memory module; and
transmitting the contents of the local latches along with the local clock to an other memory module or controller in the cascaded interconnect system.

18. The storage medium of claim 17 wherein the storage medium includes further instructions for:
generating local data at the memory module; and
merging the local data with the contents of the local latches, wherein the local data is transmitted along with the contents of local latches and the local clock.

19. The storage medium of claim 17 wherein the local clock receives a reference oscillator from the forwarded interface clock.

20. The storage medium of claim 19 wherein the local clock is created by adding a deterministic delay and applying a phased locked loop to the forwarded interface clock.

21. The storage medium of claim 17 wherein the receiving and transmitting are via a unidirectional memory bus.

22. The storage medium of claim 21 wherein the memory bus is an upstream memory bus.

23. The storage medium of claim 21 wherein the memory bus is a downstream memory bus.

24. A dual inline memory module (DIMM), comprising:
a card having a length of about 151.2 to about 151.5 millimeters and a key;
a plurality of individual local memory devices attached to said card;
a buffer device attached to said card, said buffer device configured for converting a packetized memory interface; and
said card including at least 276 pins configured thereon, wherein power pins and ground pins span the key
